(19) United States
(12) Patent Application Publication
(10) Pub. No.: US 2020/0302314 A1
(43) Pub. Date: Sep. 24, 2020

(54) MODEL GENERATION SYSTEM, DESIGN INFORMATION ACQUISITION SYSTEM, DESIGN SUPPORT SYSTEM, MODEL GENERATION METHOD, AND DESIGN INFORMATION ACQUISITION METHOD

(71) Applicant: Murata Manufacturing Co., Ltd., Kyoto (JP)

(72) Inventors: Yusaku MUROYA, Kyoto (JP); Kanta MOTOKI, Kyoto (JP); Yasunori DAIDOU, Kyoto (JP)

(21) Appl. No.: 16/821,203

(22) Filed: Mar. 17, 2020

(30) Foreign Application Priority Data
Mar. 20, 2019 (JP) 2019-053697

(51) Int. Cl. G06N 5/04; G06N 20/00

(52) U.S. Cl. CPC G06N 5/04; G06N 20/00

(57) ABSTRACT

A model generation system is a system for supporting the design of a transmitter circuit including a power amplifier. The model generation system includes an acquisition unit and a model generation unit. The acquisition unit acquires amplification performance data relating to performance of the transmitter circuit. The model generation unit generates an inference model on the basis of input data and output data using machine learning in which at least the amplification performance data is the input data and a characteristic value of the transmitter circuit is the output data.

This application claims priority from Japanese Patent Application No. 2019-053697 filed on Mar. 20, 2019. The content of this application is incorporated herein by reference in its entirety.

### BACKGROUND

The present disclosure generally relates to model generation systems, design information acquisition systems, design support systems, model generation methods, and design information acquisition methods, and programs thereof. In particular, the present disclosure relates to a model generation system, a design information acquisition system, a design support system, a model generation method, and a design information acquisition method, and programs thereof, which support the design of an amplifier circuit including a power amplifier.

A technique for evaluating in the design stage whether a high frequency power amplifier meets a target specification or not is well known in the art (for example, see Japanese Unexamined Patent Application Publication No. 2003-141201).

In Japanese Unexamined Patent Application Publication No. 2003-141201 (Patent Document 1), it is evaluated in the design stage whether the adjacent channel leakage power ratio of a high frequency power amplifier meets a target specification or not. Specifically, in a simulation method of the Patent Document 1, configuration elements and internal wirings of a high frequency power amplifier module are tentatively determined, an equivalent circuit of the tentatively-determined module is formed, a characteristic simulation is performed, and based on a result of the characteristic simulation, it is determined whether the target specification is met or not.

### BRIEF SUMMARY

There is a need for highly accurate evaluation of a high frequency power amplifier, particularly a communication circuit (amplifier circuit) including a high frequency power amplifier.

The present disclosure provides a model generation system, a design information acquisition system, a design support system, a model generation method, a design information acquisition method, and programs thereof, which facilitate the accuracy improvement of evaluation of an amplifier circuit.

A model generation system according to one aspect of the present disclosure is a system for supporting the design of an amplifier circuit including a power amplifier. The model generation system includes an acquisition unit and a model generation unit. The acquisition unit acquires amplification performance data relating to performance of the amplifier circuit. The model generation unit generates an inference model on the basis of input data and output data using machine learning in which at least the amplification performance data is the input data and a characteristic value of the amplifier circuit is the output data.

A design information acquisition system according to one aspect of the present disclosure is a system for supporting the design of an amplifier circuit including a power amplifier. The design information acquisition system includes an inference unit and an output unit. The inference unit infers a characteristic value of the amplifier circuit that is a design target based on an inference model generated by a model generation system using a combination of design performance data relating to performance of the amplifier circuit that is a design target and condition data relating to performance of the amplifier circuit that is a design target, the design performance data being obtained by simulating the amplifier circuit that is a design target. The output unit outputs the characteristic value acquired by the inference unit.

A design support system according to one aspect of the present disclosure includes a model generation system and a design information acquisition system and is a system for supporting the design of an amplifier circuit including a power amplifier. The model generation system includes an acquisition unit and a model generation unit. The acquisition unit acquires amplification performance data relating to performance of the amplifier circuit. The model generation unit generates an inference model on the basis of input data and output data using machine learning in which at least the amplification performance data is the input data and a characteristic value of the amplifier circuit is the output data. The design information acquisition system includes an inference unit and an output unit. The inference unit infers the characteristic value of the amplifier circuit that is a design target based on the inference model generated by the model generation system using a combination of design performance data relating to performance of the amplifier circuit that is a design target and condition data relating to performance of the amplifier circuit that is a design target, the design performance data being obtained by simulating the amplifier circuit that is a design target. The output unit outputs the characteristic value acquired by the inference unit.

A model generation method according to one aspect of the present disclosure is used in a model generation system for supporting the design of an amplifier circuit including a power amplifier. The model generation method includes an acquisition step and a model generation step. The acquisition step acquires amplification performance data relating to performance of the amplifier circuit. The model generation step generates an inference model on the basis of input data and output data using machine learning in which at least the amplification performance data is the input data and a characteristic value of the amplifier circuit is the output data.

A program according to one aspect of the present disclosure is a program to enable a computer system to implement the model generation method.

A design information acquisition method according to one aspect of the present disclosure is used in a design information acquisition system for supporting the design of an amplifier circuit including a power amplifier. The design information acquisition method includes an inference step and an output step. The inference step infers a characteristic value of the amplifier circuit that is a design target based on an inference model generated by a model generation system using a combination of design performance data relating to performance of the amplifier circuit that is a design target and condition data relating to performance of the amplifier circuit that is a design target, the design performance data being obtained by simulating the amplifier circuit that is a design target. The output step outputs the characteristic value acquired by the inference step.

A program according to one aspect of the present disclosure is a program to enable a computer system to implement the design information acquisition method.

Other features, elements, characteristics and advantages of the present disclosure will become more apparent from the following detailed description of embodiments of the present disclosure with reference to the attached drawings.

### BRIEF DESCRIPTION OF THE SEVERAL VIEWS OF THE DRAWINGS

FIG. 1 is a block diagram illustrating a configuration of a design support system according to one embodiment of the present disclosure;

FIG. 2 is a graph diagram illustrating a load characteristic of a power amplifier according to one embodiment of the present disclosure;

FIG. 3 is a flowchart illustrating operation of a model generation device included in the foregoing design support system; and

FIG. 4 is a flowchart illustrating operation of a design information acquisition device included in the foregoing design support system.

### DETAILED DESCRIPTION

### Embodiment

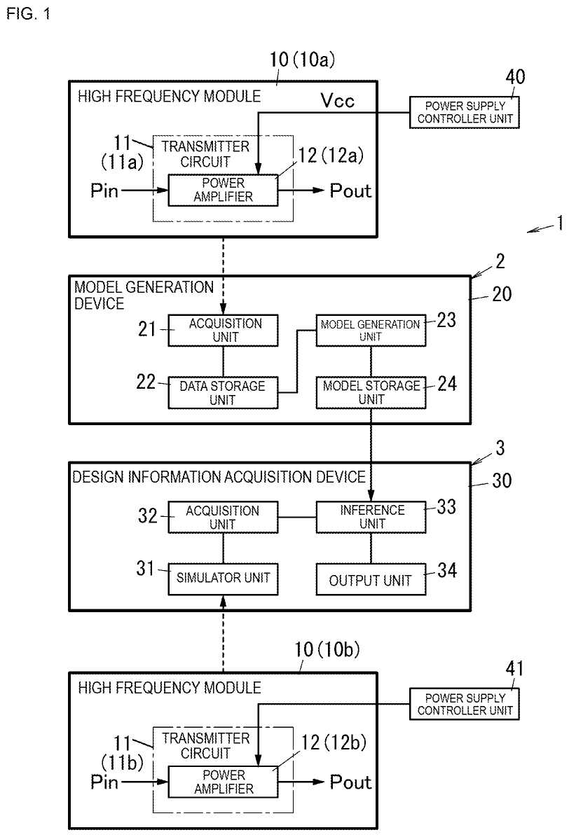

Hereinafter, a design support system according to the present embodiment is described with reference to FIGS. 1 to 4.

### (1) Outline

As illustrated in FIG. 1, a design support system 1 includes a model generation device 20 that serves as a model generation system 2 and a design information acquisition device 30 that serves as a design information acquisition system 3.

The design support system 1 supports the design of a high frequency module 10, particularly a transmitter circuit 11 included in the high frequency module 10. Specifically, the design support system 1 supports the design of the transmitter circuit 11 that serves as an amplifier circuit including a power amplifier 12 using an inference model generated by machine learning. The model generation device 20 of the design support system 1 generates an inference model whose output value is a characteristic value of the transmitter circuit 11 using machine learning whose input data is transmission performance data at least indicating performance of the transmitter circuit 11. The transmission performance data serves as amplification performance data. With regard to the transmitter circuit 11 that is a design target, the design information acquisition device 30 of the design support system 1 outputs the characteristic value associated with the transmitter circuit 11 that is a design target based on the inference model.

The transmitter circuit 11 included in the high frequency module 10 includes, in addition to the power amplifier 12, an inductor, a bias circuit, a matching circuit, a multilayer board, and the like. In the present embodiment, the power amplifier 12 is a transistor formed of, for example, a heterojunction bipolar transistor (HBT) and is an amplifying element that amplifies an input signal Pin input from the outside. Note that the high frequency module 10 may include a receiver circuit. In the case where the high frequency module 10 includes a receiver circuit, the high frequency module 10 further includes a duplexer.

In the present embodiment, the transmitter circuit 11 amplifies a signal using envelope tracking (ET) technique. Specifically, a power supply voltage Vcc is determined by a power supply controller unit 40 (see FIG. 1), which is an ET modulator, using envelope tracking technique and input to the power amplifier 12 of the transmitter circuit 11, and a power value of an output signal Pout that corresponds to the input signal Pin input from the outside is controlled.

Note that in the following description, the high frequency module 10 used in the model generation system 2 is referred to as a high frequency module 10a, and the high frequency module 10 used in the design information acquisition system 3 is referred to as a high frequency module 10b.

### (2) Configuration

In the following, the configurations of the model generation device 20 that serves as the model generation system 2 and the design information acquisition device 30 that serves as the design information acquisition system 3 are described. The model generation device 20 and the design information acquisition device 30 constitute the design support system 1.

### (2-1) Model Generation Device

As illustrated in FIG. 1, the model generation device 20 includes an acquisition unit 21, a data storage unit 22, a model generation unit 23, and a model storage unit 24.

The model generation device 20 that serves as the model generation system 2 includes, for example, a computer system including a processor and a memory. Further, the computer system functions as the model generation device 20 when the processor executes a program stored in the memory. Here, the program to be executed by the processor is recorded in advance in the memory of the computer system. Alternatively, the program may be recorded on a non-transitory recording medium such as a memory card or the like or may be provided through an electric communication line such as the Internet or the like.

The acquisition unit 21 acquires the transmission performance data relating to transmission performance of a transmitter circuit 11a of the high frequency module 10a. Specifically, the acquisition unit 21 acquires the transmission performance data including a load characteristic of a power amplifier 12a using envelope tracking technique and gain compression in the power amplifier 12a.

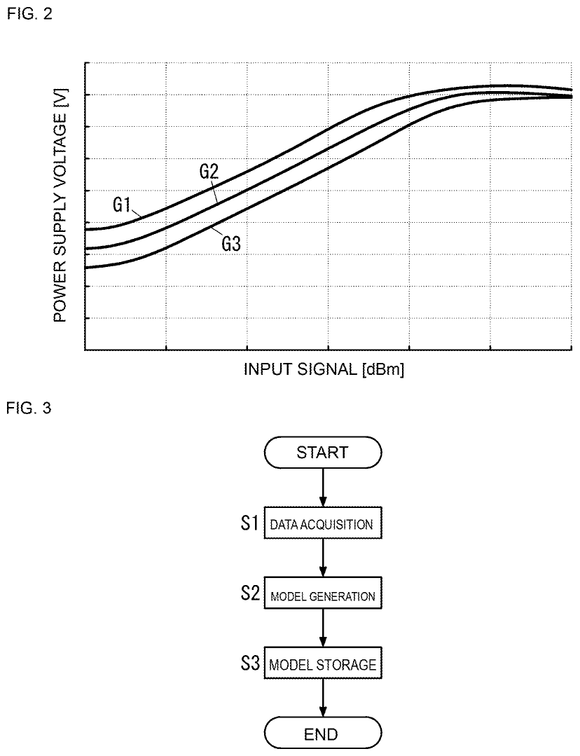

The load characteristic of the power amplifier 12a is, for example, a load characteristic curve representing a relationship between the value converted from an input value of the input signal Pin input to the power amplifier 12a in decibel (dBm) and the value converted from the value of the power supply voltage Vcc input to the power amplifier 12a in voltage (V). As described above, the power supply voltage Vcc is controlled by the power supply controller unit 40. The load characteristic curve varies depending on the value of the gain compression. For example, three load characteristic curves G1 to G3 illustrated in FIG. 2 can be obtained as the load characteristic curves for three gain compressions that are different from each other.

The gain compression is also referred to as compression point and means the reduction in gain caused by an increase of the power of the input signal Pin. In other words, the gain compression indicates a degree of the reduction in gain. In the present embodiment, the acquisition unit 21 acquires, as the gain compression, a differential value between the value in the case where the gain is constant and the reduced value

The acquisition unit 21 acquires adjacent channel leakage power ratio (adjacent channel leakage ratio: ACLR) in the case where the transmitter circuit 11a operates by using envelope tracking technique. Further, the acquisition unit 21 acquires at least one of an output value (voltage value) of the output signal Pout output from the power amplifier 12a and a resource block (RB) that is an assigned bandwidth, as learning condition data relating to the transmission performance of the transmitter circuit 11a.

The data storage unit 22 is formed of a device such as a random-access memory (RAM), an electrically erasable programmable read only memory (EEPROM), or the like. The data storage unit 22 stores ACLR in connection with the transmission performance data and the learning condition data acquired by the acquisition unit 21.

The model generation unit 23 generates an inference model on the basis of input data and output data using the machine learning in which the transmission performance data and the learning condition data are the input data and a characteristic value (inference characteristic value) of the transmitter circuit 11a is the output data.

In the case where there is a plurality of pairs of the transmission performance data and the learning condition data, the model generation unit 23 generates an inference model for each set of the pair of the transmission performance data and the learning condition data and the corresponding ACLR. That is to say, in the case where there is a plurality of pairs of the transmission performance data and the learning condition data, a plurality of inference models is generated.

In the model generation unit 23, each of the transmission performance data and the learning condition data, which are the input data, is represented as a feature value, and each feature value is multiplied by a weighting coefficient. The model generation unit 23 repeats the multiplication while changing the weighting coefficient in such a way that an obtained result approaches ACLR. The model generation unit 23 sets a finally obtained result (inference characteristic value) and a pair of the transmission performance data and the learning condition data, which are the input data, as the inference model.

The model storage unit 24 is formed of a device such as a RAM, an EEPROM, or the like. The model storage unit 24 stores the inference model generated by the model generation unit 23 for each foregoing pair.

Note that the data storage unit 22 and the model storage unit 24 may be formed of a single device.

### (2-2) Design Information Acquisition Device

As illustrated in FIG. 1, the design information acquisition device 30 includes a simulator unit 31, an acquisition unit 32, an inference unit 33, and an output unit 34.

The design information acquisition device 30 that serves as the design information acquisition system 3 includes, for example, a computer system including a processor and a memory. Further, the computer system functions as the design information acquisition device 30 when the processor executes a program stored in the memory. Here, the program to be executed by the processor is recorded in advance in the memory of the computer system. Alternatively, the program may be recorded on a non-transitory recording medium such as a memory card or the like or may be provided through an electric communication line such as the Internet or the like.

The simulator unit 31 simulates a transmitter circuit 11b (see FIG. 1) of the high frequency module 10b that is a design target. In this case, a power supply voltage determined by a power supply controller unit 41 (see FIG. 1), which is an ET modulator, using envelope tracking technique is input to a power amplifier 12b of the transmitter circuit 11b, and a power value of the output signal Pout corresponding to the input signal Pin is controlled. The simulator unit 31 receives, from a user, data including at least one of an output value (voltage value) of a signal output from the power amplifier 12b for the transmitter circuit 11b and a RB that is an assigned bandwidth, as condition data relating to transmission performance of the transmitter circuit 11b. The simulator unit 31 simulates the transmitter circuit 11b based on the condition data and outputs, as a result the simulation, a load characteristic curve in envelope tracking technique regarding the power amplifier 12b included in the transmitter circuit 11b. That is to say, the simulator unit 31 outputs a load characteristic curve.

In the case where each one of a plurality of the transmitter circuits 11b of the high frequency modules 10b is simulated, the simulator unit 31 receives the condition data for each transmitter circuit 11b, which is a simulation target, and the gain compression. The simulator unit 31 performs, for each transmitter circuit 11b, a simulation based on the condition data associated with the transmitter circuit 11b. The simulator unit 31 outputs, for each transmitter circuit 11b, the simulation result of the transmitter circuit 11b, the gain compression, and the condition data.

The acquisition unit 32 acquires the simulation result of the transmitter circuit 11b obtained by the simulator unit 31 (load characteristic curve of the power amplifier 12b) as well as the gain compression and the condition data input to the simulator unit 31. The acquisition unit 32 outputs the load characteristic curve of the power amplifier 12b, the gain compression, and the condition data, which have been acquired, to the inference unit 33.

In the case where the simulator unit 31 simulates a plurality of the transmitter circuits 11b, the acquisition unit 32 acquires, for each transmitter circuit 11b, the simulation result (load characteristic curve of the power amplifier 12b) of the transmitter circuit 11b, the gain compression, and the condition data.

The inference unit 33 infers a characteristic value according to the simulation of the transmitter circuit 11b and the condition data. Specifically, the inference unit 33 infers the characteristic value of the transmitter circuit 11b based on the inference model generated by the model generation device 20 using a combination of design performance data relating to the transmission performance of the transmitter circuit 11b and the condition data relating to the transmission performance of the transmitter circuit 11b. The design performance data includes the simulation result obtained by simulating the transmitter circuit 11b and the gain compression.

In the inference unit 33, each of the design performance data and the condition data of the transmitter circuit 11b is represented as a feature value, and for each inference model stored in the model storage unit 24, the corresponding feature value is multiplied by the weighting coefficient included in the inference model. Of the multiplication results obtained for each inference model, the inference unit 33 selects the multiplication result closest to the inference characteristic value included in the corresponding inference model. The inference unit 33 infers (acquires) the selected multiplication result as the characteristic value of the transmitter circuit lib.

Note that the inference unit 33 may infer (acquire) that the inference characteristic value included in the inference model associated with the selected multiplication result is the characteristic value of the transmitter circuit lib. Alternatively, of the multiplication results obtained for each inference model, the inference unit 33 may select the multiplication result that is closest to the inference characteristic value included in the corresponding inference model and whose error from the inference characteristic value included in the corresponding inference model is within a predetermined range.

Note that in the case where the acquisition unit 32 acquired, for each transmitter circuit lib, the simulation result of the transmitter circuit 11b and the condition data, the inference unit 33 infers (acquires) the characteristic value of the transmitter circuit 11b for each transmitter circuit lib.

The output unit 34 outputs (sends) the characteristic value of the transmitter circuit 11b inferred (acquired) by the inference unit 33 to an information terminal of a user. The information terminal that received a characteristic value of the transmitter circuit 11b displays the characteristic value on a display unit of the information terminal. Note that in the case where the design information acquisition device 30 includes a display unit, the output unit 34 may output the characteristic value to the display unit of the design information acquisition device 30 and cause the display unit to display the characteristic value. That is to say, the output unit 34 has a function to cause the display unit to display the characteristic value of the transmitter circuit 11b inferred (acquired) by the inference unit 33. The information terminal is a terminal such as, for example, a smartphone, a tablet terminal, a personal computer, or the like.

In the case where the inference unit 33 infers (acquires) the characteristic value of the transmitter circuit 11b for each of a plurality of the transmitter circuits 11b, the output unit 34 outputs a plurality of the characteristic values respectively associated with the plurality of the transmitter circuits 11b. In this case, when displaying a plurality of characteristic values on a display unit of an output destination, the output unit 34 causes the display unit to display the plurality of characteristic values according to a predetermined condition. Here, the predetermined condition means to display the characteristic values in ascending order or display the characteristic values in descending order.

Further, in the case where a plurality of characteristic values is displayed, the output unit 34 also outputs the simulation results, the gain compressions, and the condition data, which are respectively associated with the plurality of characteristic values so as to display a plurality of sets each including the characteristic value and the corresponding simulation result, gain compressions, and condition data. This allows a user to know easily which characteristic values are results of which simulations.

### (3) Operation

### (3-1) Operation of Model Generation Device

Here, operation of the model generation device 20 is described with reference to FIG. 3.

The acquisition unit 21 acquires a variety of data to be used in generation of an inference model (step S1). Specifically, the acquisition unit 21 acquires the transmission performance data including the load characteristic of the power amplifier 12a using envelope tracking technique and the gain compression, ACLR of the transmitter circuit 11a, and the learning condition data including at least one of the output value (voltage value) of the output signal Pout and the RB that is an assigned bandwidth. The acquisition unit 21 stores the transmission performance data and the learning condition data, which have been acquired, in connection with ACLR in the data storage unit 22.

The model generation unit 23 generates an inference model on the basis of input data and output data using the machine learning in which the transmission performance data and the learning condition data are the input data and the characteristic value (inference characteristic value) of the transmitter circuit 11a is the output data (step S2). In the case where there is a plurality of pairs of the transmission performance data and the learning condition data, the model generation unit 23 generates an inference model for each set including the pair of the transmission performance data and the learning condition data and the corresponding ACLR.

The model generation unit 23 stores the generated inference model in the model storage unit 24 (step S3). Note that in the case where a plurality of inference models is generated, the model generation unit 23 stores each of the plurality of inference models in the model storage unit 24.

### (3-2) Operation of Design Information Acquisition Device

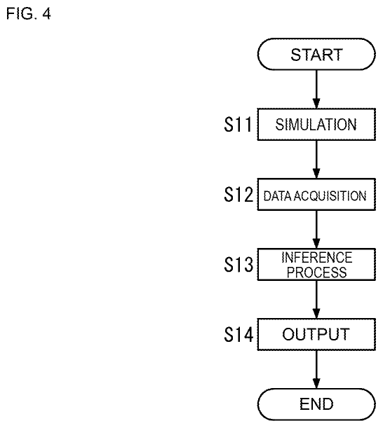

Here, operation of the design information acquisition device 30 is described with reference to FIG. 4.

The simulator unit 31 receives the condition data for the transmitter circuit 11b of the high frequency module 10b, which is a design target, and simulates the transmitter circuit 11b based on the condition data (step S11). Here, as described above, the condition data is the data including at least one of the output value (voltage value) of the signal output from the power amplifier 12b for the transmitter circuit 11b and the RB that is an assigned bandwidth, and is the data relating to transmission performance of the transmitter circuit 11b. The simulator unit 31 simulates the transmitter circuit 11b based on the condition data and as a result thereof, outputs a load characteristic curve in envelope tracking technique regarding the power amplifier 12b included in the transmitter circuit 11b.

Note that in the case where each one of a plurality of the transmitter circuits 11b of the high frequency modules 10b is simulated, the simulator unit 31 receives the gain compression and the condition data for each transmitter circuit 11b, which is a simulation target. The simulator unit 31 performs, for each transmitter circuit 11b, a simulation based on the condition data associated with the transmitter circuit 11b. The simulator unit 31 outputs, for each transmitter circuit 11b, the simulation result of the transmitter circuit 11b, the gain compression, and the condition data.

The acquisition unit 32 acquires the simulation result of the transmitter circuit 11b obtained by the simulator unit 31, the gain compression, and the condition data (step S12). Note that in the case where the simulator unit 31 simulates a plurality of the transmitter circuits 11b, the acquisition unit 32 acquires, for each transmitter circuit 11b, the simulation result of the transmitter circuit 11b, the gain compression, and the condition data.

The inference unit 33 infers the characteristic value of the transmitter circuit 11b based on the inference model generated by the model generation device 20 using a combination of design performance data relating to the transmission performance of the transmitter circuit 11b and the condition data relating to the transmission performance of the transmitter circuit 11b (step S13). The design performance data includes the simulation result and the gain compression of the transmitter circuit lib. Note that in the case where the acquisition unit 32 acquired, for each transmitter circuit lib, the simulation result of the transmitter circuit lib, the gain compression, and the condition data, the inference unit 33 infers (acquires) the characteristic value of the transmitter circuit 11b for each transmitter circuit lib.

The output unit 34 outputs (informs of) the characteristic value of the transmitter circuit 11b inferred (acquired) by the inference unit 33 (step S14). For example, the output unit 34 outputs the characteristic value of the transmitter circuit 11b to an information terminal of a user. At this time, the information terminal that received a characteristic value of the transmitter circuit 11b displays the characteristic value on a display unit of the information terminal. Here, in the case where the inference unit 33 infers (acquires) the characteristic value of the transmitter circuit 11b for each of a plurality of the transmitter circuits lib, the output unit 34 outputs a plurality of the characteristic values respectively associated with the plurality of the transmitter circuits lib. In this case, when displaying a plurality of the characteristic values on a display unit of an output destination, the output unit 34 causes the display unit to display the plurality of characteristic values according to a predetermined condition.

### (4) Advantages

As described above, the design support system 1 of the embodiment 1 enables to accurately infer the characteristic value of the transmitter circuit 11b for the input data (transmission performance data and condition data) of the transmitter circuit 11b, which is a design target, based on the inference model generated by the model generation device 20 using the machine learning. Here, the transmission performance data is data obtained by ET technique. Therefore, the design support system 1 of the embodiment 1 enables to accurately infer the characteristic value as the transmission performance of the transmitter circuit 11b in consideration of ET technique. That is to say, the design support system 1 of the embodiment 1 enables to facilitate the improvement of accuracy in evaluating the transmission performance of the transmitter circuit 11b in consideration of ET technique.

Further, when generating the inference model using the machine learning, the model generation device 20 uses the respective feature values of the transmission performance data and the learning condition data of the transmitter circuit 11a. This enables the model generation device 20 to calculate non-linear performance of the transmitter circuit 11a.

Further, the characteristic curve of the power amplifier 12 included in the transmitter circuit 11 represents the relationship between the input power and the power supply voltage Vcc for obtaining a desired gain (power amplification). Further, in the case where the transmitter circuit 11 includes a duplexer, the duplexer contributes to the attenuation of a signal at each frequency. In the characteristic curve of the power amplifier 12 of the transmitter circuit 11 including the duplexer, an influence of this attenuation appears in increase and decrease of gain, which is increase and decrease of the power supply voltage Vcc. Therefore, it can be said that the characteristic curve of the power amplifier 12 includes frequency characteristics of the duplexer.

Further, the design information acquisition device 30 infers the transmission performance (characteristic value) of the transmitter circuit 11b using the inference model generated by the model generation device 20, and thus it is likely to obtain improved transmission performance. In other words, because it is possible to specify the input data that gives improved transmission performance, design work can be performed efficiently.

### (5) Modified Example

Modified examples are listed below. Note that the modified examples described below may be combined with the foregoing embodiment if appropriate.

### (5-1) Modified Example 1

The transmission performance data may include information obtained from the load characteristic of the transmitter circuit 11a and the gain compression.

As another modified example of the transmission performance data, the transmission performance data may include information relating to digital pre-distortion (DPD). For example, the transmission performance data may include information regarding whether DPD is performed or not.

### (5-2) Modified Example 2

Further, in the foregoing embodiment, it is assumed that a signal is amplified using ET technique. However, in the case where the input signal Pin, which is input to the transmitter circuit 11, has a low voltage, there is no need to use ET technique.

In view of the above, in the case where the input signal Pin input to the transmitter circuit 11a has a low voltage, the model generation unit 23 may generate an inference model based on transmission performance data and condition data that do not use ET technique. Similarly, in the case where a signal input to the transmitter circuit 11b has a low voltage, the inference unit 33 may infer the characteristic value using the inference model generated based on transmission performance data and condition data that do not use ET technique.

This enables the design information acquisition device 30 to perform an accurate inference even in the case where the transmitter circuit 11b, which is a design target, does not use ET technique. Therefore, it is possible to facilitate the improvement of accuracy in evaluating the transmission performance of the transmitter circuit 11b.

### (5-3) Modified Example 3

In the foregoing embodiment, the inference characteristic value output from the machine learning of the model generation unit 23 and the characteristic value inferred by the inference unit 33 are assumed to be ACLR of the corresponding transmitter circuit 11. However, the inference characteristic value output from the machine learning of the model generation unit 23 and the characteristic value inferred by the inference unit 33 are not limited to ACLR.

The inference characteristic value output from the machine learning of the model generation unit 23 and the characteristic value inferred by the inference unit 33 may be in-band distortion power (Error Vector Magnitude: EVM) in the corresponding transmitter circuit 11.

Alternatively, the inference characteristic value output from the machine learning of the model generation unit 23 and the characteristic value inferred by the inference unit 33 may be one of ACLR and EVM selected by a user.

### (5-4) Modified Example 4

In the foregoing embodiment, the description is provided using the transmitter circuit 11 including the power amplifier 12 as an example. However, the foregoing embodiment is not limited thereto, and the design support system 1 is also applicable to a receiver circuit including a low noise amplifier, which serves as a power amplifier. That is to say, the model generation by the model generation unit 23 may be applicable to a receiver circuit that functions as an amplifier circuit including a low noise amplifier. In this case, the inference unit 33 outputs a characteristic value of the receiver circuit that is a design target.

### (5-5) Modified Example 5

In the foregoing embodiment, the inference unit 33 may acquire the transmission performance data and the condition data directly from the simulator unit 31. In this case, a function that enables the inference unit 33 to acquire the transmission performance data and the condition data from the simulator unit 31 corresponds to the acquisition unit.

### (5-6) Modified Example 6

In the foregoing embodiment, the simulator unit 31 is assumed to be a configuration element of the design information acquisition device 30. However, the simulator unit 31 may be not a configuration element of the design information acquisition device 30. That is to say, the simulator unit 31 may be provided as a device separate from the design information acquisition device 30.

Further, in another modified example, the data storage unit 22 may be not a configuration element of the model generation device 20. That is to say, the model generation system 2 may include the model generation device 20 and a data storage unit 22 that is a device separate from the model generation device 20. Alternatively, the model generation system 2 may not include the data storage unit 22. Similarly, the model storage unit 24 may be not a configuration element of the model generation device 20. That is to say, the model generation system 2 may include the model generation device 20 and a model storage unit 24 that is a device separate from the model generation device 20. Alternatively, the model generation system 2 may not include the data storage unit 24.

### (5-7) Other Modified Examples

The foregoing embodiment is one of various embodiments of the present disclosure. The foregoing embodiment may be modified in various ways depending on the design and the like of the present disclosure.

Functions similar to the model generation system 2 may be realized by a non-transitory recording medium or the like, on which a model generation method, a computer program, or a program is recorded. A model generation method according to one aspect is used in a model generation system for supporting the design of the transmitter circuit 11 including the power amplifier 12. The model generation method includes an acquisition step and a model generation step. The acquisition step acquires the transmission performance data relating to the transmission performance of the transmitter circuit 11. The model generation step generates the inference model on the basis of input data and output data using machine learning in which at least the transmission performance data is the input data and the characteristic value of the transmitter circuit 11 is the output data. A program according to one aspect is a program for enabling a computer system to function as the model generation method described above.

Functions similar to the design information acquisition system 3 may be realized by a non-transitory recording medium or the like, on which a design information acquisition method, a computer program, or a program is recorded. A design information acquisition method according to one aspect is used in a design information acquisition system for supporting the design of the transmitter circuit 11 including the power amplifier 12. The design information acquisition method includes an inference step and an output step. The inference step infers a characteristic value of the transmitter circuit 11, which is a design target, based on the inference model generated by the model generation system 2 using a combination of the design performance data relating to the transmission performance of the transmitter circuit, which is a design target, and the condition data relating to the transmission performance of the transmitter circuit, which is a design target. The design performance data obtained by simulating the transmitter circuit 11, which is a design target. The output step outputs the characteristic value acquired by the inference step. A program according to one aspect is a program for enabling a computer system to function as the design information acquisition method described above.

Further, the model generation system 2 may be a system including one or more computers. Similarly, the design information acquisition system 3 may be a system including one or more computers.

### CONCLUSION

From the above-described embodiment and the like, the following aspects are described.

A model generation system (2) of a first aspect is a system for supporting the design of an amplifier circuit (for example, the transmitter circuit 11) including a power amplifier (12). The model generation system (2) includes an acquisition unit (21) and a model generation unit (23). The acquisition unit (21) acquires amplification performance data relating to performance of the amplifier circuit (for example, the transmitter circuit 11a). The model generation unit (23) generates an inference model on the basis of input data and output data using machine learning in which at least the amplification performance data is the input data and a characteristic value of the amplifier circuit is the output data.

This configuration enables accurate evaluation of the amplifier circuit that is a design target based on the inference model generated by the model generation system (2) using the machine learning. That is to say, the model generation system (2) enables to facilitate the improvement of accuracy in evaluating the amplifier circuit that is a design target.

In a model generation system (2) of a second aspect, in the first aspect, the amplification performance data includes a load characteristic of a power amplifier (12a) using envelope tracking technique and gain compression in the power amplifier (12a). Alternatively, the amplification performance data includes information obtained from the load characteristic and the gain compression.

This configuration enables accurate evaluation of the amplifier circuit in which power efficiency is improved by ET technique based on the inference model generated by the model generation system (2) using the machine learning.

In a model generation system (2) of a third aspect, in the first or second aspect, the characteristic value includes at least one of adjacent channel leakage power ratio and in-band distortion power.

This configuration enables accurate evaluation based on at least one of the adjacent channel leakage power ratio and the in-band distortion power generated by the model generation system (2) using the machine learning.

A design information acquisition system (3) of a fourth aspect is a system for supporting the design of an amplifier circuit (for example, a transmitter circuit 11) including the power amplifier (12). The design information acquisition system (3) includes an inference unit (33) and an output unit (34). The inference unit (33) infers a characteristic value of the amplifier circuit that is a design target based on an inference model generated by the model generation system (2) of any of the first to third aspects using a combination of design performance data relating to performance of the amplifier circuit that is a design target and condition data relating to performance of the amplifier circuit that is a design target, the design performance data being obtained by simulating the amplifier circuit (for example, the transmitter circuit lib) that is a design target. The output unit (34) outputs the characteristic value acquired by the inference unit (33).

This configuration enables accurate evaluation of the amplifier circuit because the performance (characteristic value) of the amplifier circuit is inferred using the inference model generated by the model generation system (2). Accordingly, it is possible to increase the possibility of obtaining improved performance. In other words, because it is possible to specify the input data that gives improved performance, design work can be performed efficiently. That is to say, the design information acquisition system (3) enables to facilitate the improvement of accuracy in evaluating the amplifier circuit that is a design target.

In a design information acquisition system (3) of a fifth aspect, in the fourth aspect, for each of a plurality of the combinations, the inference unit (33) acquires the characteristic value of the amplifier circuit that is a design target corresponding to the combination. The output unit (34) causes a display unit (for example, a display unit of an information terminal) to display the characteristic values of the amplifier circuit that is a design target in such a way that the characteristic values of the amplifier circuit that is a design target are arranged according to a display condition.

This configuration allows a user (designer of the amplifier circuit) to know easily which one of the plurality of combinations provides improved performance, that is, the input data that gives improved performance.

A design support system (1) of a sixth aspect includes the model generation system (2) and the design information acquisition system (3) and is a system for supporting the design of an amplifier circuit (for example, the transmitter circuit 11) including the power amplifier (12). The model generation system (2) includes an acquisition unit (21) and a model generation unit (23). The acquisition unit (21) acquires amplification performance data relating to performance of the amplifier circuit (for example, the transmitter circuit 11a). The model generation unit (23) generates an inference model on the basis of input data and output data using machine learning in which at least the amplification performance data is the input data and a characteristic value of the amplifier circuit is the output data. The design information acquisition system (3) includes an inference unit (33) and an output unit (34). The inference unit (33) infers a characteristic value of the amplifier circuit that is a design target based on the inference model generated by the model generation system (2) using a combination of design performance data relating to performance of the amplifier circuit that is a design target and condition data relating to performance of the amplifier circuit that is a design target, the design performance data being obtained by simulating the amplifier circuit (for example, the transmitter circuit 11b) that is a design target. The output unit (34) outputs the characteristic value acquired by the inference unit (33).

This configuration enables accurate evaluation of the amplifier circuit that is a design target based on the inference model generated by the model generation system (2) using the machine learning. That is to say, the design support system (1) enables to facilitate the improvement of accuracy in evaluating the amplifier circuit that is a design target.

A model generation method of a seventh aspect is used in a model generation system for supporting the design of an amplifier circuit (for example, the transmitter circuit 11) including the power amplifier (12). The model generation method includes an acquisition step and a model generation step. The acquisition step acquires amplification performance data relating to performance of the amplifier circuit (for example, the transmitter circuit 11). The model generation step generates an inference model on the basis of input data and output data using machine learning in which at least the amplification performance data is the input data and a characteristic value of the amplifier circuit is the output data.

This model generation method enables accurate evaluation of the amplifier circuit that is a design target based on the inference model generated by the model generation system (2) using the machine learning. This also enables to facilitate the improvement of accuracy in evaluating the amplifier circuit that is a design target.

A program of an eighth aspect is a program to enable a computer system to implement the model generation method of the seventh aspect.

This program enables accurate evaluation of the amplifier circuit that is a design target based on the inference model generated by the model generation system (2) using the machine learning. This also enables to facilitate the improvement of accuracy in evaluating the amplifier circuit that is a design target.

A design information acquisition method of a ninth aspect is used in a design information acquisition system for supporting the design of an amplifier circuit (for example, the transmitter circuit 11) including the power amplifier (12). The design information acquisition method includes an inference step (33) and an output step (34). The inference unit (33) infers a characteristic value of the amplifier circuit that is a design target based on an inference model generated by the model generation system (2) of any of the first to third aspects using a combination of design performance data relating to performance of the amplifier circuit that is a design target and condition data relating to performance of the amplifier circuit that is a design target, the design performance data being obtained by simulating the amplifier circuit (for example, the transmitter circuit lib) that is a design target. The output step outputs the characteristic value acquired by the inference step.

This design information acquisition method enables accurate evaluation of the amplifier circuit because the performance (characteristic value) of the amplifier circuit is inferred using the inference model generated by the model generation system (2). This also enables to facilitate the improvement of accuracy in evaluating the amplifier circuit that is a design target.

A program of a tenth aspect is a program to enable a computer system to implement the design information acquisition method of the ninth aspect.

This program enables accurate evaluation of the amplifier circuit because the performance (characteristic value) of the amplifier circuit is inferred using the inference model generated by the model generation system (2). This also enables to facilitate the improvement of accuracy in evaluating the amplifier circuit that is a design target.

While embodiments of the disclosure have been described above, it is to be understood that variations and modifications will be apparent to those skilled in the art without necessarily departing from the scope and spirit of the disclosure. The scope of the disclosure, therefore, is to be determined solely by the following claims.

What is claimed is:

1. A model generation system for supporting design of an amplifier circuit including a power amplifier, the model generation system comprising:
at least one processor and memory configured to:
acquire amplification performance data relating to performance of the amplifier circuit; and
generate an inference model by machine learning, wherein at least the amplification performance data is input data to the machine learning and a characteristic value of the amplifier circuit is output data from the machine learning.

2. The model generation system according to claim 1, wherein the amplification performance data comprises:
a load characteristic of the power amplifier acquired using an envelope tracking technique and gain compression in the power amplifier, or
information obtained from the load characteristic and the gain compression.

3. The model generation system according to claim 1, wherein the characteristic value comprises an adjacent channel leakage power ratio or an in-band distortion power.

4. The model generation system according to claim 2, wherein the characteristic value comprises an adjacent channel leakage power ratio or an in-band distortion power.

5. A design information acquisition system for supporting design of an amplifier circuit including a power amplifier, the model generation system comprising:
at least one processor and memory configured to:
based on the inference model generated by the model generation system according to claim 1, infer the characteristic value of the amplifier circuit by using a combination of design performance data relating to performance of the amplifier circuit and condition data relating to performance of the amplifier circuit as the amplification performance data that is input data, the design performance data being obtained by simulating the amplifier circuit; and
output the inferred characteristic value.

6. The design information acquisition system according to claim 5, wherein the at least one processor and memory of the design information acquisition system are configured to:
infer the characteristic value corresponding to the combination from the model generation system, for each of a plurality of combinations of design performance data and condition data, and
output the inferred characteristic values by causing a display to display the characteristic values such that the characteristic values are arranged according to a display condition.

7. A design support system for supporting design of an amplifier circuit including a power amplifier, the design support system comprising:
the model generation system according to claim 1; and
a design information acquisition system comprising at least one processor and memory configured to:
based on the inference model generated by the model generation system, infer the characteristic value of the amplifier circuit by using a combination of design performance data relating to performance of the amplifier circuit and condition data relating to performance of the amplifier circuit as the amplification performance data that is input data, the design performance data being obtained by simulating the amplifier circuit; and
output the inferred characteristic value.

8. A model generation method for use in a model generation system for supporting design of an amplifier circuit including a power amplifier, the model generation method comprising:
acquiring amplification performance data relating to performance of the amplifier circuit; and
generating an inference model by machine learning, wherein at least the amplification performance data is input data to the machine learning and a characteristic value of the amplifier circuit is output data from the machine learning.

9. The model generation method according to claim 8, wherein the amplification performance data comprises:
a load characteristic of the power amplifier acquired using an envelope tracking technique and gain compression in the power amplifier, or
information obtained from the load characteristic and the gain compression.

10. The model generation system according to claim 8, wherein the characteristic value comprises an adjacent channel leakage power ratio or an in-band distortion power.

11. The model generation system according to claim 9, wherein the characteristic value comprises an adjacent channel leakage power ratio or an in-band distortion power.

12. A non-transitory computer-readable medium having instructions stored thereon that, when executed by a computer, cause the computer to perform the model generation method according to claim 8.

13. A design information acquisition method for use in a design information acquisition system for supporting design of an amplifier circuit including a power amplifier, the design information acquisition method comprising:
based on the inference model generated by the model generation method according to claim 8, inferring the characteristic value of the amplifier circuit by using a combination of design performance data relating to performance of the amplifier circuit and condition data relating to performance of the amplifier circuit as the amplification performance data that is input data, the design performance data being obtained by simulating the amplifier circuit that is a design target; and
outputting the inferred characteristic value.

14. The design information acquisition method according to claim 13, wherein:
the method comprises inferring the characteristic value corresponding to each of a plurality of combinations of design performance data and condition data, and
the method further comprises outputting the inferred characteristic values by displaying the characteristic values such that the characteristic values are arranged according to a display condition.

15. A non-transitory computer-readable medium having instructions stored thereon that, when executed by a computer, cause the computer to perform the design information acquisition method according to claim 13.
